(19) United States
(12) Patent Application Publication
(10) Pub. No.: US 2025/0148709 A1
(43) Pub. Date: May 8, 2025

(54) SYSTEMS AND METHODS IN DIGITAL IMAGE PROCESSING FOR GENERATING GRAPHICAL THREE-DIMENSIONAL MODELS OF THE REAL-WORLD ENVIRONMENT FROM TWO OR MORE TWO-DIMENSIONAL IMAGES

(71) Applicant: HL Acquisition, Inc. d/b/a Hosta AI, Cambridge, MA (US)

(72) Inventors: Rachelle Villalon, Cambridge, MA (US); Tuanfeng Zhang, Cambridge, MA (US); Heetika Gada, Cambridge, MA (US)

(21) Appl. No.: 18/938,629

(22) Filed: Nov. 6, 2024

Related U.S. Application Data
(60) Provisional application No. 63/596,641, filed on Nov. 7, 2023.

(51) Int. Cl. G06T 17/00; G06T 7/13; G06T 7/70; G06V 10/764

(52) U.S. Cl. CPC G06T 17/00; G06T 7/13; G06T 7/70; G06V 10/764; G06T 2207/30242

(57) ABSTRACT

A computer-implemented method for generating a three-dimensional (3D) digital model from one or more two-dimensional images is described. The method includes: obtaining, though an application programming interface (API), a series of two-dimensional (2D) images of a scene taken by an image capturing device; extracting, by a processing device, key images from the series of 2D images, wherein each of the key images depicts one or more components of a building structure in the scene; determining, by the processing device, and based on the extracted key images, a respective position and a respective direction of the image capturing device relative to each of the one or more components of the building structure; and processing, using a 3D image generation neural network, the extracted key images and the positions and directions of the image capturing device to generate metadata comprising a three-dimensional (3D) digital model of the building structure.

### CLAIM OF PRIORITY

This application claims priority under 35 U.S.C. § 119(e) to U.S. Provisional Patent Application Ser. No. 63/596,641, filed on Nov. 7, 2023, and entitled “SYSTEMS AND METHODS IN DIGITAL IMAGE PROCESSING FOR GENERATING GRAPHICAL THREE-DIMENSIONAL MODELS OF THE REAL-WORLD ENVIRONMENT FROM TWO OR MORE TWO-DIMENSIONAL IMAGES,” the entire contents of which is hereby incorporated by reference.

### BACKGROUND

This description generally relates to generating three-dimensional (3D) digital models of objects and components of a building structure in the built environment.

Video and depth sensor technologies have been used to process sensor data into 3D models that represent structure of the built environment. Such 3D models can be used in commercial applications for various purposes, such as in developing “as built” documentation. For example, the 3D models can be used in property assessments, which are positioned at the center of home appraisals, insurance claims, renovation projects, and a number of other real-estate-related processes. Inaccurate or delayed assessments can set projects back and result in higher costs for consumers.

### SUMMARY

In general, one innovative aspect of the subject matter described in this specification can be embodied in a computer-implemented method for generating a three-dimensional (3D) digital image from a series of two-dimensional (2D) images. The method includes obtaining, through an application programming interface (API), a series of 2D images of a scene taken by an image capturing device. The method includes extracting, by a processing device, key images from the series of 2D images, in which each of the key images depicts one or more components of a building structure in the scene. The method includes determining, by the processing device, and based on the extracted key images, a respective position and a respective direction of the image capturing device relative to each of the one or more components of the building structure. The method includes processing, using a 3D image generation neural network, the extracted key images and the positions and directions of the image capturing device to generate metadata comprising a 3D digital model of the building structure.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The series of 2D images may be frames of a video. In particular, obtaining, through the API, the series of 2D images of the scene may include: obtaining, through the API, a video of the scene taken by the image capturing device; and converting, by the processing device, the video into the series of 2D images. Extracting, by the processing device, the key images from the series of 2D images may include extracting one or more images that depict edges of at least one component of the building structure. The edges may define a boundary of at least one component of the building structure. At least one component of the building structure may include a wall, a ceiling, a window, a door, a floor, or a staircase. Extracting, by the processing device, the key images from the series of 2D images may include counting a number of distinct objects depicted in the plurality of images. Extracting, by the processing device, the key images from the series of 2D images may includes: for each image of the plurality of images, calculating a percentage of pixel overlap between the image and a next image. The image capturing device may be a camera or a mobile device. The metadata may include a floor plan of the building structure. The metadata may include measurements of the one or more components of the building structure. The metadata may include, for each of the one or more components of the building structure, data specifying at least one of (i) a material that the component is made of, or (ii) a quantity of the material that the component is made of. The metadata may include data specifying one or more damages to the one or more components of the building structure.

Another innovative aspect of the subject matter described in this specification can be embodied in a computer-implemented method for 3D image processing with image unwarping and corner restoration. The method includes: determining if a wall layout originates from a predefined automation or labeling process; reading room reconstruction parameters from a specified path; accessing a directory with images and data files; loading RGB images and association JSON files into a memory; identifying damaged and non-damaged rooms through a damage super-category within the JSON files; processing the RGB images to validate and adjust wall layouts, restore polygon corners, and perform unwarping tasks; classifying unwarped entities based on a type of each unwarped entity; storing relevant unwarping data; and generating a new parameters file for subsequent reconstruction activities. In some implementations, restoring polygon corners includes identifying and restoring cut-off wall polygons using image dimensions and layout polygons of ceilings and floors. In some implementations, the computer-implemented method further includes generating a placeholder wall layout using three middle wall polygons.

The subject matter described in this specification can be implemented in particular embodiments so as to realize one or more of the following advantages.

The techniques described in this specification allow a data processing system to automatically generate graphical 3D digital models and other useful information of a building structure from a video or a series of 2D images of a scene. Existing methods require collecting and processing extensive sensor data from different types of sensors and measurements of the building structure in order to construct 3D maps. As the sensor data and measurements are usually manually obtained by an on-site personnel, this process is time-consuming and must be repeated if any data is missing or incorrect due to human errors. In contrast, the described techniques can construct 3D digital models from a video or a series of 2D images in minutes by using a 3D model generation neural network, thereby simplifying the way existing building data is captured and processed. As a result, systems that implement the described techniques can reduce the amount of data storage and computational resources that would otherwise be required by existing systems to store and process extensive sensor data and manual measurements. In addition, by using an advanced scene understanding engine to extract scene understanding information from both input images and extracted key images, the described system can reduce errors in detecting objects and improve accuracy of the scene understanding information compared to existing systems. Further, by implementing a dynamic resolution NeRF neural network to construct graphical 3D models, the described system can improve the accuracy and quality of the output graphical 3D models in comparison to 3D models outputted by existing systems. In addition, the dynamic resolution NeRF network integrates additional components to enhance the predictive and reconstructive capabilities of the algorithm. Further, the dynamic resolution NeRF neural network utilizes generative artificial intelligence mechanisms for the 3D reconstruction process, allowing the system to infer and generate data patterns that are not explicitly present in the original inputs.

In addition to generating accurate 3D digital models in minutes, the described techniques can analyze 2D images to produce other useful information about the building structure such as precise measurements of spaces, detailed floor plans, and bills of materials. The described techniques can also evaluate the conditions of materials to assess damage and identify risks, such as the use of flammable materials or inadequate sprinkler to volume ratios. The outputs of the described data processing system can be readily portable into industry applications, such as property assessment applications, allowing for more accurate and quicker assessments of a property, thereby reducing time and costs associated with processes that require property assessments (e.g., home appraisals, insurance claims, renovation projects, etc.). Further, the described techniques can eliminate the need to have someone onsite to assess the property and can reduce errors associated with manual assessments.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a computing environment including a data processing system for generating a 3D digital model from a series of 2D images.

FIG. 2 is a flow diagram of an example process for extracting key images from a video.

FIG. 3 shows examples of an output of a 3D model generation neural network.

FIG. 4 is a flow diagram of an example process for generating scene understanding information from a series of 2D images.

FIG. 5 is a flow diagram of an example process for constructing a 3D digital model of a building structure.

FIG. 6 is a flow diagram of an example process for generating a 3D digital model from a video or a series of 2D images.

FIG. 7 depicts an example computing system, according to implementations of the present disclosure.

Like reference numbers and designations in the various drawings indicate like elements.

### DETAILED DESCRIPTION

This specification describes systems and methods for generating 3D digital models of objects and components of a building structure in the real-world built environment from a video or a series of 2D images.

The techniques described in this specification allow a data processing system to automatically generate 3D digital models and other useful information of a building structure from a video or a series of two-dimensional (2D) images of a scene, without requiring extensive sensor data or manual measurements. A 3D digital model is a graphical representation of the real-world environment and is expressed in geometric coordinates. The 3D digital model allows users to interact with the model in three dimensions through a graphical user interface (GUI). Through the GUI, users can manipulate the 3D digital model in many different ways, e.g., to move, rotate, zoom in, zoom out, scale up, or scale down the model.

Existing methods require collecting and processing extensive sensor data from different types of sensors and measurements of the building structure in order to construct 3D models. As the sensor data and measurements are usually manually obtained by an on-site personnel, this process is time-consuming and must be repeated if any data is missing or incorrect due to human errors. In contrast, the described techniques can construct 3D digital models from a video or a series of 2D images in minutes by using a 3D model generation neural network, thereby simplifying the way existing building data is captured and processed.

In particular, the 3D model generation neural network includes a dynamic resolution neural radiance field (NeRF) network. The dynamic resolution NeRF network applies a flexible resolution mechanism that dynamically adjusts a ray sampling density based on the intricacy of the scene being processed, optimizing computational resources and enhancing the accuracy and quality of the output 3D model in comparison to 3D models outputted by existing systems. Further, the dynamic resolution NeRF network integrates additional components to enhance the predictive and reconstructive capabilities of the algorithm. In addition, the dynamic resolution NeRF neural network utilizes generative artificial intelligence mechanisms for the 3D reconstruction process, allowing the system to infer and generate data patterns that are not explicitly present in the original inputs.

As a result, systems that implement the described techniques can reduce the amount of data storage and computational resources that would otherwise be required by existing systems to store and process extensive sensor data and manual measurements. In addition to generating accurate 3D digital models in minutes, the described techniques can analyze 2D images to produce other useful information about the building structure such as precise measurements of spaces, detailed floor plans, and bills of materials. The described techniques can also evaluate the conditions of materials to assess damage and identify risks, such as the use of flammable materials or inadequate sprinkler to volume ratios. The outputs of the described data processing system can be readily portable into industry applications, such as property assessment applications, allowing for more accurate and quicker assessments of a property, thereby reducing time and costs associated with processes that require property assessments (e.g., home appraisals, insurance claims, renovation projects, etc.). Further, the described techniques can eliminate the need to have someone onsite to assess the property and can reduce errors associated with manual assessments.

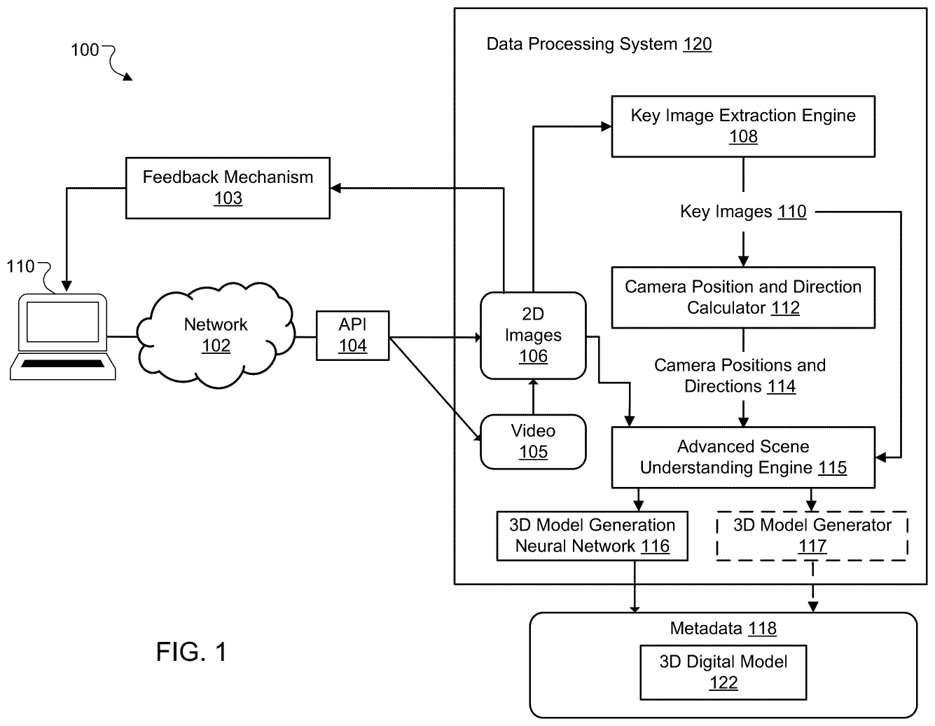

FIG. 1 shows an example of a computing environment including a data processing system for generating 3D digital models of objects and components of a building structure in the built environment from a video or a series of 2D images.

The computing environment 100 includes a data processing system 120 and a user device (also referred to as “a client device”) 110. The data processing system 120 is an example of a server system implemented as computer programs on one or more computers in one or more locations, in which the systems, components, and techniques described below can be implemented. The user device 110 can include any appropriate type of computing device such as a desktop computer, a laptop computer, a handheld computer, a tablet computer, a personal digital assistant (PDA), a cellular telephone, a network appliance, a camera, a smart phone, a smart watch, an enhanced general packet radio service (EGPRS) mobile phone, a media player, a navigation device, an email device, a game console, or an appropriate combination of any two or more of these devices or other data processing devices.

The data processing system 120 includes a key image extraction engine 108, a camera position and direction calculator 112, and a 3D model generation neural network 116. Each of the key image extraction engine 108, the camera position and direction calculator 112, and a 3D model generation neural network 116 is an engine that is implemented as one or more software modules or components, installed on one or more computers in one or more locations. In some cases, one or more computers will be dedicated to a particular engine; in other cases, multiple engines can be installed and running on the same computer or computers.

The user device 110 can communicate with the data processing system 120 via a communication network 102. The communication network 118 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

Through the communication network 102, the user device 110 invokes an Application Programming Interface (API) 104 associated with the data processing system 120 in order to transmit a video or a series of 2D images 106 of a scene to the data processing system 120. The video or the series of 2D images are taken by an image capturing device, which may be a camera, a smart phone, a tablet computer, or any device that has the capability of taking videos and/or pictures.

As shown in the example of FIG. 1, the user device 110 is a laptop of a user who wants to obtain a 3D digital model and optionally, other useful information of a building structure (hereafter also referred to as “the property”). The user may be a person in charge of the property, a building professional, or any person or entity that needs or is interested in obtaining a 3D digital model of the property. For example, the user may be an owner of the property, an entity managing the property, an appraiser, an insurer, an adjuster, a mortgage lender, or a construction contractor. In some implementations, the user device 110 transmits a series of 2D images 106 to the data processing system 120 through the communication network 102 and the API 104. In some other implementations, the user device 110 transmits a video 105 to the data processing system 120 through the communication network 102 and the API 104. In these implementations, the data processing system 120 converts the video 105 into the series of 2D images (or 2D frames) 106 before processing the 2D images further. In some implementations, the data processing system 120 implements a feedback mechanism 103 in which the 2D images 106 are transmitted to the user device 110 for the user to check the 2D images 106 and send feedback about the images, if any, to the data processing system 120. For example, the user may provide feedback that one or more of the images are missing, or an image was not correctly taken according to one or more criteria.

The video 105 or the series of 2D images 106 are a video/images of a scene of the built environment and are taken by an image processing device. In some implementations, the scene includes an interior of a room or an exterior of a building structure. The building structure may be a residential property, an office, building, a retail establishment, or any other types of real-estate property. In some other implementations, the scene includes the exterior of a building structure.

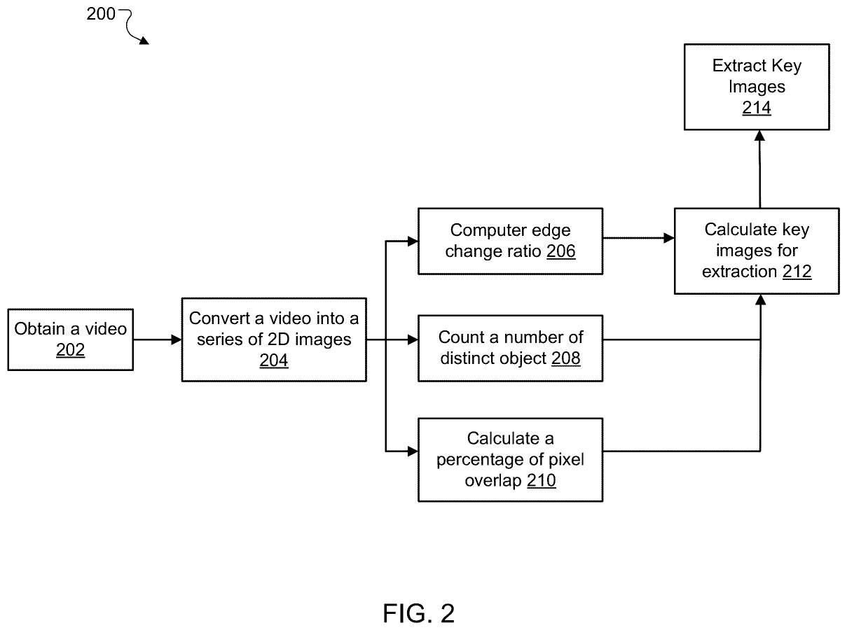

The system 120 then extracts key images from the series of 2D images 106 using the key image extraction engine 108. A key image is an image that contains key pixels that include important information about one or more components of the building structure in the scene. For example, a key image may include key pixels that depict one or more edges of a component of the building structure that define a boundary of the component. As another example, a key image may include key pixels that depict a material that the component is made of. As yet another example, a key image may include key pixels that depict a damage to the component. A component of the building structure may be a wall, a ceiling, a window, a door, a floor, a kitchen, a kitchen island, or a staircase. For example, a key image may depict edges of a wall that specify where the wall starts and ends. The process for extracting key images from a video is described in more detail below with references to FIG. 2.

The system 120 determines, based on the extracted key images, a respective position and a respective direction of the image capturing device relative to each of the one or more components of the building structure. For simplicity, in the following description, the image capturing device is referred to as the “camera,” although any type of image capturing device could be used to capture the video/2D images of the scene.

To determine the camera position and directions, the system 120 uses a computer vision detection module to detect key points (that include key pixels) that represent distinct objects and components of the building structure (e.g., detecting edges of structural components, edges of objects, and other distinct features of the building structure) in each image. The system 120 then generates, from the extracted key images, a camera path in the video. The camera path is the path taken by the camera to capture the images/video in the given environment. The camera path entails the position and direction of the camera relative to each objects or components of the building structure. After computing the key frames and the key points in the image, the system 120 computes, for each of the key images, the translational and rotational matrices of the key points in the key image after ordering the key points.

Based on the camera path and the translational and rotational matrices of the key points in the key images, the camera position and direction calculator 112 computes the camera positions and directions 114, which include a respective position and direction of the camera relative to each of the objects and components through the fundamentals of projective geometry.

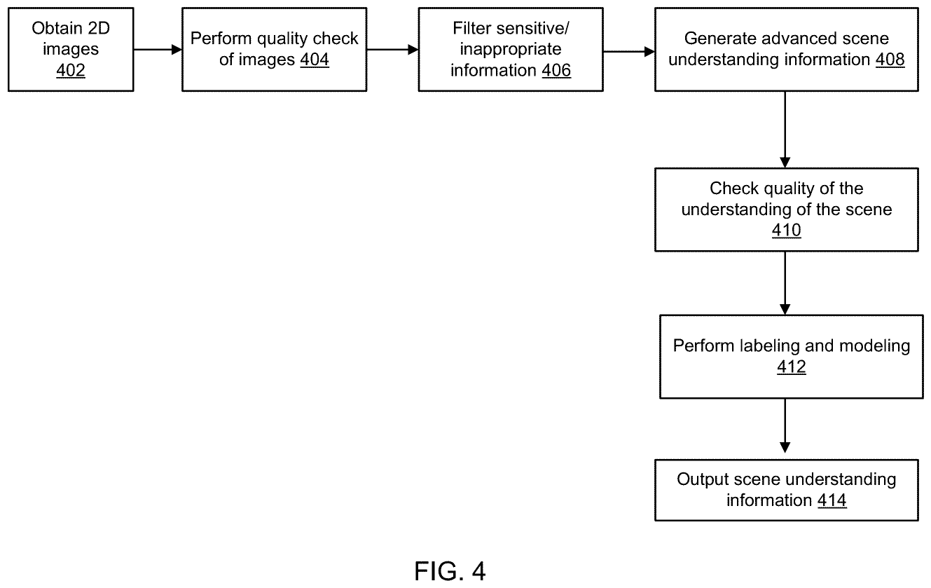

The system 120 processes the 2D images 106 and the key images 110 using the advanced scene understanding engine 115 to generate scene understanding information of the scene. The process for extracting scene understanding information from images is described in detail below with reference to FIG. 4.

The system 120 processes, using the 3D model generation neural network 116, the scene understanding information and the positions and directions of the image capturing device to generate an output that includes the metadata 118. Optionally, the system 120 may process the scene understanding information and the camera positions and directions 114 using a 3D model generator 117 to generate the output that includes the metadata 118. The system 120 may choose whether to use the 3D model generator 117 based on a type of a room in the built environment.

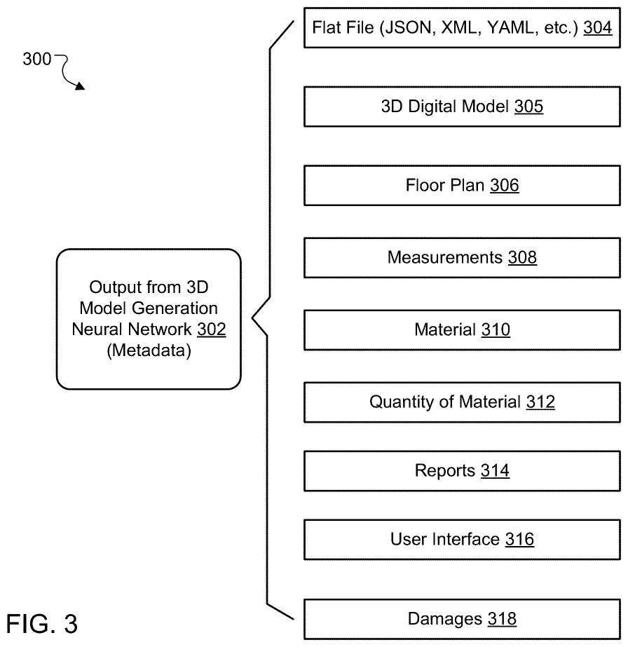

The metadata 118 includes a 3D digital model 122 of the building structure. Generating an output that includes the metadata 118 includes reconstructing the scene to form the 3D digital model 122. In some implementations, the metadata 118 includes a floor plan of the building structure. In some implementations, the metadata 118 includes measurements of the one or more components of the building structure. In some implementations, the metadata 118 includes, for each of the one or more components of the building structure, data specifying a material that the component is made of. In some implementations, the metadata 118 includes, for each of the one or more components of the building structure, a quantity of the material that the component is made of. In some implementations, the metadata 118 includes data specifying one or more damages to the one or more components of the building structure. Examples of an output of a 3D model generation neural network are described in more detailed below with reference to FIG. 3.

To generate an output that includes the metadata 118, the 3D model generation neural network processes the extracted key images and the positions and directions of the image capturing device as well as the scene understanding information using a dynamic resolution neural radiance field (NeRF) neural network, which is a fully-connected neural network.

The dynamic resolution NeRF neural network includes a NeRF neural network and an adaptive sampling neural network layer. Examples of a NeRF neural network are described in Ben Mildenhall, Pratul P. Srinivasan, Matthew Tancik, Jonathan T. Barron, Ravi Ramamoorthi, Ren Ng, “NeRF: Representing Scenes as Neural Radiance Fields for View Synthesis,” available at https://doi.org/10.48550/arXiv.2003.08934.

The adaptive sampling neural network layer is configured to recognize areas of high detail or complexity within the scene and dynamically modify the ray sampling density in those areas. This method ensures an efficient allocation of computational resources by focusing on areas where detail is most needed and reducing focus on less complex areas.

The dynamic resolution NeRF neural network integrates generative artificial intelligence (AI) mechanisms that not only reconstructs scenes but also populates them with realistic and contextually appropriate details that may not be present in the original 2D input images or in the 2D images extracted from an input video. This adaptive generation process is guided by a semantic understanding of the scene, allowing for the reaction of more rich and detailed environments.

Furthermore, the dynamic resolution NeRF neural network incorporates a real-time feedback mechanism that enables the system to learn and refine its predictive capabilities continuously. In particular, the system 120 As the system processes more data, it fine-tunes its adaptive sampling strategies, improving both the speed and accuracy of the 3D reconstructions over time and enabling the generation of novel elements within the 3D space, predicting and inserting realistic objects, textures, and environmental details based on the learned patterns from extensive training datasets.

FIG. 2 is a flow diagram of an example process for extracting key images from a video. For convenience, the process 200 will be described as being performed by a system of one or more computers located in one or more locations. For example, a data processing system, e.g., the data processing system 120 of FIG. 1, appropriately programmed in accordance with this specification, can perform the process 200.

The system receives a video that captures a scene (202). In some implementations, the scene includes an interior of a room or an exterior of a building structure. The building structure may be a residential property, an office building, a retail establishment, or any other types of real-estate property. In some other implementations, the scene includes the exterior of a building structure.

The system converts the video into a series of selected 2D images (204). In particular, the video includes a sequence of 2D images. The system receives the video as input and sets a dynamic sample rate of extraction of images based on the quality of each image in the sequence. In some implementations, the system only extracts an image and includes the image in the series of selected 2D images when the quality of the image exceeds a threshold level.

The system computes an edge change ratio of the video (206). The edge change ratio is the ratio of one image to another image with respect to the changed pixels between two images. The system takes one layout edge in one image and determines the differences in pixels with the same layout edge in the other image. For example, in a video of an indoor room, the computed edge change ratio visibly sees the edges of walls within the 2D images of the video to understand where a wall begins and ends.

The system detects distinct objects and counts the number of distinct objects in the series of 2D image (208). In particular, the system may use one or more neural networks to detect and classify distinct objects in the scene.

For each image in the series of 2D images, the system calculates a percentage of pixel overlap between the image and the next image in the series. In particular, the system may observe the similarities of the two images. The system may perform feature extraction to extract a plurality of feature points from the images and store these feature points. Each pixel in the image is assigned a feature point from the plurality of feature points. Based on the feature point assigned to each pixel in the image, the system computes the percentage of pixel overlap between the two images.

Based on the edge change ratio, the number of distinct objects, and the percentage of pixel overlap between each image and the next image, the system calculates key images for extraction (212). In particular, the system combines the edge change ratio, the number of distinct objects, and the percentage of pixel overlap and rates a probabilistic value of similarity between two images. This similarity is ordered and the key frames are chosen algorithmically based on this probability.

The system then extracts the key images from the series of 2D images (214).

FIG. 3 shows examples of an output of a 3D model generation neural network 116 or the 3D model generator 117.

The output of the 3D model generation neural network 116 can include flat files such as JSON, XML, YAML, and other formats for machine to machine readability and processing of information. The output includes metadata, which includes a 3D digital model that represents the building structure and one or more of the following: a floor plan 306 or object contour of the 3D digital model; measurements 308 of objects and components of the building structure; for each of the components and/or object, data representing the material 310 of the component and/or object, and data representing the quantity 312 of the material 310; reports 314 about the scene representation in the 3D digital model and other data relevant to the scene or objects that is generated; or a user interface 316 in which content for user interface interactions as well as statistical reports are displayed to the user. In the event that the scene representation in the 3D digital model includes existing conditions of damages, damage information 318 is included in the output 302 and recorded for further analysis and processing.

FIG. 4 is a flow diagram of an example process for generating scene understanding information from a series of 2D images. For convenience, the process 400 will be described as being performed by a system of one or more computers located in one or more locations. For example, a data processing system, e.g., the data processing system 120 of FIG. 1, appropriately programmed in accordance with this specification, can perform the process 400.

The system obtains a series of 2D images 402 as input data. The system performs quality check of the series of 2D images (step 402). For example, the system may check one or more of (i) the order of images in the series, (ii) blurriness of one or more of the 2D images, or (iii) darkness of one or more of the 2D images. The system filters out sensitive information or inappropriate information from one or more of the 2D images (step 406). For example, personal identifiable information such as faces and/or credit card numbers is filtered out.

The system processes the filtered images to generate scene understanding information (step 408). In particular, the system extracts information about the scene from the filter images. For instances, the system extracts information and data related to objects, materials, layouts, depths of the images, vanishing points, and/or relationships of objects with other objects.

The system checks quality of the scene understanding information (step 410). In particular, the system can automatically perform quality check of the scene understanding information using a set of rules about the scene. For instance, the system checks if a detected sink is close to a detected faucet. If the detected sink is close to a detected faucet, then the scene understanding information has a good quality. In another instance, the system can check if the image of the scene is dark or blurry. In this way, the system can extract quality of the generated scene understanding information.

The system performs labeling and modeling of the scene understanding information (step 412). In particular, the system can automatically label through the scene understanding step and automatically model through the 3D reconstruction step.

Finally, the system outputs the scene understanding information (step 414).

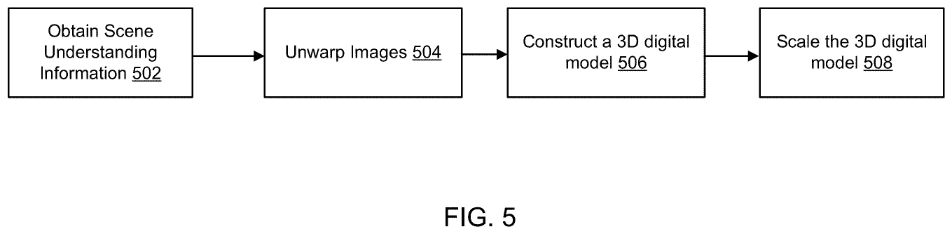

FIG. 5 is a flow diagram of an example process for constructing a 3D digital model of a building structure from scene understanding information. For convenience, the process 500 will be described as being performed by a system of one or more computers located in one or more locations. For example, a data processing system, e.g., the data processing system 120 of FIG. 1, appropriately programmed in accordance with this specification, can perform the process 500.

The system obtains scene understanding information (step 502). The process for generating scene understanding information is described in detail in FIG. 4. The system un-warps the filtered images by removing perspective from the filtered images to generate an un-warped output (step 504). The system removes perspective of the image by dynamically calculating and assuming the angle of the image. Once the system has computed this angle, the system resets the image to a format which contains no perspective.

Based on the unwarped output, the system generates 3D information of the scene and constructs a 3D digital model of the building structure in the scene (step 506). In some implementations, the system constructs the 3D digital model by using a 3D model generation neural network (e.g., by using a NeRF neural network as discussed above).

In some implementations, the system may construct the 3D digital model by using a 3D model generator that employs one or more algorithms (e.g., fitting walls algorithm). For example, the 3D model generator may use a homography matrix to unwarp images as well as employ one or more algorithms to solve for wall deduplication (filters for a collection of 3D objects with unique orientations not found in the source object), wall ordering (where each wall is ordered along a world-space direction with a rotation angle), corner restoration (an image processing method that identifies centered walls in an image and attempts to restore its polygon corner points if wall polygons are cut), and missing information from images such as wall, floors, and ceilings. Based on the 3D information and 3D digital model, the system scales the 3D digital model to an appropriate size. Optionally, the system adds measurements to the 3D digital model.

In some implementations, the system performs 3D image processing with image unwarping and corner restoration. In particular, the system determines if a wall layout originates from a predefined automation or labeling process; reads room reconstruction parameters from a specified path; accesses a directory with images and data files; loads RGB images and association JSON files into a memory; identifying damaged and non-damaged rooms through a damage super-category within the JSON files; processes the RGB images to validate and adjust wall layouts, restore polygon corners, and perform unwarping tasks; classifies unwarped entities based on a type of each unwarped entity; stores relevant unwarping data; and generates a new parameters file for subsequent reconstruction activities. In some implementations, restoring polygon corners includes identifying and restoring cut-off wall polygons using image dimensions and layout polygons of ceilings and floors. In some implementations, the system further generates a placeholder wall layout using three middle wall polygons.

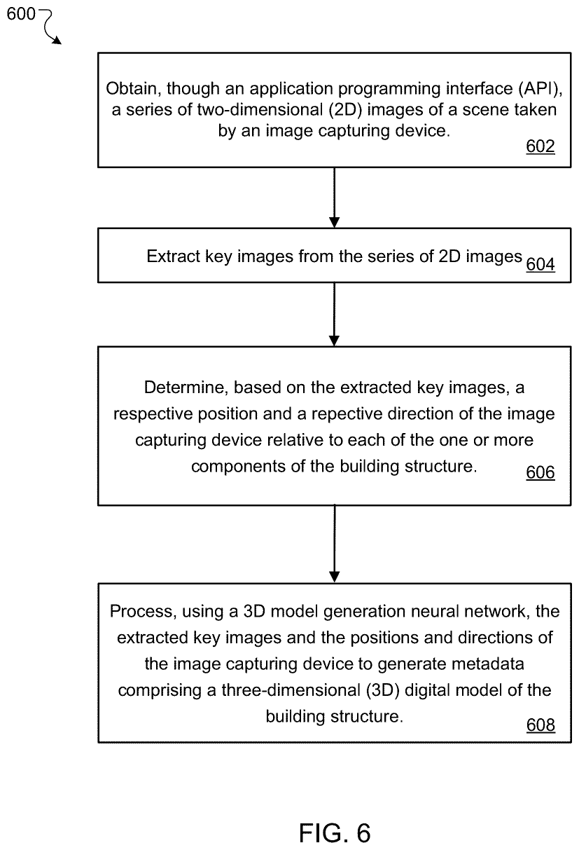

FIG. 6 is a flow diagram of an example process for generating a 3D digital model from a video or a series of 2D images. For convenience, the process 600 will be described as being performed by a system of one or more computers located in one or more locations. For example, a data processing system, e.g., the data processing system 120 of FIG. 1, appropriately programmed in accordance with this specification, can perform the process 600.

The system obtains, though an application programming interface (API), a series of two-dimensional (2D) images of a scene taken by an image capturing device (step 602). In some implementations, the system obtains the series of 2D images of the scene directly from the user device through the API. In some other implementations, the system obtains, though the API, a video of the scene taken by the image capturing device, and converting the video into the series of 2D images. The image capturing device may be a camera or a mobile device.

The system extracts key images from the series of 2D images (step 604). Each of the key images depicts one or more components of a building structure in the scene. The system may extract one or more images that depict edges of at least one component of the building structure, in which the edges define a boundary of the at least one component of the building structure. The at least one component of the building structure includes a wall, a ceiling, a window, a door, a floor, or a staircase. To extract the key images, the system may count a number of distinct objects depicted in the plurality of images. For each image of the plurality of images, the system may calculate a percentage of pixel overlap between the image and a next image.

The system determines and based on the extracted key images, a respective position and a respective direction of the image capturing device relative to each of the one or more components of the building structure (step 606).

The system processes, using a 3D image generation neural network, the extracted key images and the positions and directions of the image capturing device to generate metadata including a three-dimensional (3D) digital model of the building structure (step 608). The 3D model generation neural network may include a neural radiance field (NeRF) network which is a fully-connected neural network. The metadata may include a floor plan of the building structure. The metadata may include measurements of the one or more components of the building structure. The metadata may include, for each of the one or more components of the building structure, data specifying a material that the component is made of. The metadata may include, for each of the one or more components of the building structure, a quantity of the material that the component is made of. The metadata includes data specifying one or more damages to the one or more components of the building structure. Other examples of the metadata are described in detail above with reference to FIG. 3.

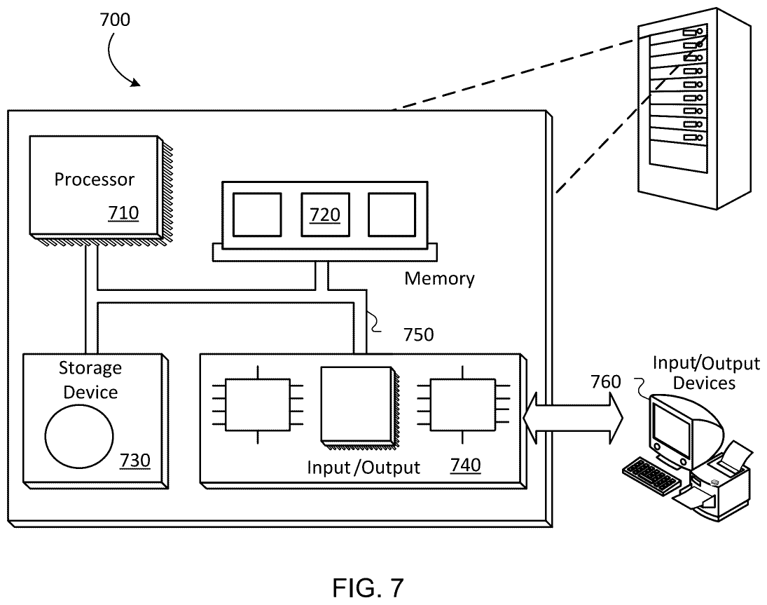

FIG. 7 depicts an example computing system, according to implementations of the present disclosure. The system 700 may be used for any of the operations described with respect to the various implementations discussed herein. The system 700 may include one or more processors 710, a memory 720, one or more storage devices 730, and one or more input/output (I/O) devices 760 controllable through one or more I/O interfaces 740. The various components 710, 720, 730, 740, or 760 may be interconnected through at least one system bus 750, which may enable the transfer of data between the various modules and components of the system 700.

The processor(s) 710 may be configured to process instructions for execution within the system 700. The processor(s) 710 may include single-threaded processor(s), multi-threaded processor(s), or both. The processor(s) 710 may be configured to process instructions stored in the memory 720 or on the storage device(s) 730. The processor(s) 710 may include hardware-based processor(s) each including one or more cores. The processor(s) 710 may include general purpose processor(s), special purpose processor(s), or both.

The memory 720 may store information within the system 700. In some implementations, the memory 720 includes one or more computer-readable media. The memory 720 may include any number of volatile memory units, any number of non-volatile memory units, or both volatile and non-volatile memory units. The memory 720 may include read-only memory, random access memory, or both. In some examples, the memory 720 may be employed as active or physical memory by one or more executing software modules.

The storage device(s) 730 may be configured to provide (e.g., persistent) mass storage for the system 700. In some implementations, the storage device(s) 730 may include one or more computer-readable media. For example, the storage device(s) 730 may include a floppy disk device, a hard disk device, an optical disk device, or a tape device. The storage device(s) 730 may include read-only memory, random access memory, or both. The storage device(s) 730 may include one or more of an internal hard drive, an external hard drive, or a removable drive.

One or both of the memory 720 or the storage device(s) 730 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 700. In some implementations, the CRSM may include a data store that provides storage of computer-readable instructions or other information in a non-transitory format. The CRSM may be incorporated into the system 700 or may be external with respect to the system 700. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 710 and the memory 720 may be supplemented by, or incorporated into, one or more application-specific integrated circuits (ASICs).

The system 700 may include one or more I/O devices 760. The I/O device(s) 760 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 760 may also include one or more output devices such as a display, LED(s), an audio output device (e.g., a speaker), a printer, a haptic output device, and so forth. The I/O device(s) 760 may be physically incorporated in one or more computing devices of the system 700, or may be external with respect to one or more computing devices of the system 700.

The system 700 may include one or more I/O interfaces 740 to enable components or modules of the system 700 to control, interface with, or otherwise communicate with the I/O device(s) 760. The I/O interface(s) 740 may enable information to be transferred in or out of the system 700, or between components of the system 700, through serial communication, parallel communication, or other types of communication. For example, the I/O interface(s) 740 may comply with a version of the RS-232 standard for serial ports, or with a version of the IEEE 1284 standard for parallel ports. As another example, the I/O interface(s) 740 may be configured to provide a connection over Universal Serial Bus (USB) or Ethernet. In some examples, the I/O interface(s) 740 may be configured to provide a serial connection that is compliant with a version of the IEEE 1394 standard.

The I/O interface(s) 740 may also include one or more network interfaces that enable communications between computing devices in the system 700, or between the system 700 and other network-connected computing systems. The network interface(s) may include one or more network interface controllers (NICs) or other types of transceiver devices configured to send and receive communications over one or more networks using any network protocol.

Computing devices of the system 700 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 700 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining, though an application programming interface (API), a series of two-dimensional (2D) images of a scene taken by an image capturing device;
extracting, by a processing device, key images from the series of 2D images, wherein each of the key images depicts one or more components of a building structure in the scene;
determining, by the processing device, and based on the extracted key images, a respective position and a respective direction of the image capturing device relative to each of the one or more components of the building structure; and
processing, using a three-dimensional (3D) image generation neural network or an image processing process, the extracted key images and the positions and directions of the image capturing device to generate metadata comprising a 3D digital model of the building structure.

2. The computer-implemented method of claim 1, wherein obtaining, though the API, the series of 2D images of the scene comprises:
obtaining, though the API, a video of the scene taken by the image capturing device; and
converting, by the processing device, the video into the series of 2D images.

3. The computer-implemented method of claim 1, wherein extracting, by the processing device, the key images from the series of 2D images comprises:
extracting one or more images that depict edges of at least one component of the building structure, wherein the edges define a boundary of at least one component of the building structure.

4. The computer-implemented method of claim 3, wherein at least one component of the building structure includes a wall, a ceiling, a window, a door, a floor, or a staircase.

5. The computer-implemented method of claim 1, wherein extracting, by the processing device, the key images from the series of 2D images comprises:
counting a number of distinct objects depicted in the plurality of images.

6. The computer-implemented method of claim 1, wherein extracting, by the processing device, the key images from the series of 2D images comprises:
for each image of the plurality of images, calculating a percentage of pixel overlap between the image and a next image.

7. The computer-implemented method of claim 1, wherein the image capturing device is a camera or a mobile device.

8. The computer-implemented method of claim 1, wherein the metadata comprises a floor plan and associated coordinates of the building structure.

9. The computer-implemented method of claim 1, wherein the metadata comprises measurements, area, and other units of measurement of the one or more components of the building structure.

10. The computer-implemented method of claim 1, wherein the metadata comprises physical properties of the one or more components of the building structure, wherein the physical properties comprise one or more of fire resistance and acoustical performance.

11. The computer-implemented method of claim 1, wherein the metadata comprises, for each of the one or more components of the building structure, data specifying a material that the component is made of.

12. The computer-implemented method of claim 11, wherein the metadata comprises, for each of the one or more components of the building structure, a quantity of the material that the component is made of.

13. The computer-implemented method of claim 1, wherein the metadata comprises data specifying one or more damages and building assessment to the one or more components of the building structure.

14. The computer-implemented method of claim 1, wherein the metadata comprises at least one of (i) a structured framework for organizing and defining information related to the building structure, (ii) common vocabulary that captures specifics of the building structure, or (iii) spatial knowledge and relationships between terms for built spaces.

15. A system comprising:
one or more processors; and
one or more non-transitory computer-readable storage media coupled to the one or more processors and having instructions stored thereon which, when executed by the one or more processors, cause the one or more processors to perform operations comprising:
obtaining, though an application programming interface (API), a series of two-dimensional (2D) images of a scene taken by an image capturing device;
extracting key images from the series of 2D images, wherein each of the key images depicts one or more components of a building structure in the scene;
determining, based on the extracted key images, a respective position and a respective direction of the image capturing device relative to each of the one or more components of the building structure; and
processing, using a 3D image generation neural network, the extracted key images and the positions and directions of the image capturing device to generate metadata comprising a three-dimensional (3D) digital model of the building structure.

16. The system of claim 15, wherein the operations for obtaining, though, the series of 2D images of the scene comprise:
obtaining, through the API, a video of the scene taken by an image capturing device; and
converting the video into the series of 2D images.

17. The system of claim 13, wherein the operations for extracting the key images from the series of 2D images comprise:
extracting one or more images that depict edges of at least one component of the building structure, wherein the edges define a boundary of the at least one component of the building structure.

18. The system of claim 17, wherein the at least one component of the building structure includes a wall, a ceiling, a window, a door, a floor, or a staircase.

19. The system of claim 15, wherein the operations for extracting the key images from the series of 2D images comprise:
counting a number of distinct objects depicted in the plurality of images.

20. The system of claim 15, wherein the operations for extracting the key images from the series of 2D images comprise:
for each frame of the plurality of images, calculating a percentage of pixel overlap between the frame and a next frame.

21. One or more non-transitory computer-readable storage media coupled to one or more processors and having instructions stored thereon which, when executed by the one or more processors, cause the one or more processors to perform operations comprising:
obtaining, though an application programming interface (API), a series of two-dimensional (2D) images of a scene taken by an image capturing device;
extracting key images from the series of 2D images, wherein each of the key images depicts one or more components of a building structure in the scene;
determining, based on the extracted key images, a respective position and a respective direction of the image capturing device relative to each of the one or more components of the building structure; and
processing, using a 3D image generation neural network, the extracted key images and the positions and directions of the image capturing device to generate metadata comprising a three-dimensional (3D) digital model of the building structure.

22. The one or more non-transitory computer-readable storage media of claim 21, wherein the operations for obtaining, though the API, the series of 2D images of the scene comprise:
obtaining, though the API, a video of the scene taken by the image capturing device; and
converting the video into the series of 2D images.

23. The one or more non-transitory computer-readable storage media of claim 21, wherein the operations for extracting the key images comprise operations for extracting key pixels that include important information about the one or more components of the building structure in the scene.

24. A computer-implemented method for 3D image processing with image unwarping and corner restoration, the method comprising:
determining if a wall layout originates from a predefined automation or labeling process;
reading room reconstruction parameters from a specified path;
accessing a directory with images and data files;
loading RGB images and association JSON files into a memory;
identifying damaged and non-damaged rooms through a damage super-category within the JSON files;
processing the RGB images to validate and adjust wall layouts, restore polygon corners, and perform unwarping tasks;
classifying unwarped entities based on a type of each unwarped entity;
storing relevant unwarping data; and
generating a new parameters file for subsequent reconstruction activities.

25. The computer-implemented method of claim 24, wherein restoring polygon corners includes identifying and restoring cut-off wall polygons using image dimensions and layout polygons of ceilings and floors.

26. The computer-implemented method of claim 24, further comprising generating a placeholder wall layout using three middle wall polygons.
